(19) United States
(12) Patent Application Publication
(10) Pub. No.: US 2013/0316055 A1
(43) Pub. Date: Nov. 28, 2013

(54) ACIDIC VISCOUS LIQUIDS FOR PROCESSING OF PERISHABLE FOODS

(71) Applicant: Jason Holt, Ball Ground, GA (US)

(72) Inventor: Jason Holt, Ball Ground, GA (US)

(21) Appl. No.: 13/794,058

(22) Filed: Mar. 11, 2013

Related U.S. Application Data
(60) Provisional application No. 61/650,525, filed on May 23, 2012.

(51) Int. Cl. A23B 4/10; A23B 4/12; A23B 7/10; A23L 3/3454

(52) U.S. Cl. CPC A23B 4/10; A23L 3/3454; A23B 4/12; A23B 7/10
USPC 426/332; 426/654; 426/335; 426/331

(57) ABSTRACT

Acidic viscous solutions are described that can be introduced for the processing of perishable food to facilitate providing antimicrobial treatments. The solutions can have a viscosity from about 50 centipoise to about 10,000 centipoise. The solution generally does not add any significant nutritional or flavor contributions to the food product. The acidic viscous solutions can be particularly useful for improving the effectiveness of subsequent hypochlorous acid/hypochlorite or peroxide antimicrobial treatments.

### CROSS REFERENCE TO RELATED APPLICATIONS

This application claims priority to U.S. Provisional Patent Application Ser. No. 61/650,525 filed on May 23, 2012 entitled “Improved Antimicrobial Control of Food Processes,” incorporated herein by reference.

### FIELD OF THE INVENTION

The invention relates to liquids for application to perishable foods to facilitate processing. The method further relates to processes for the application to a perishable food item to reduce microbial contamination, which can be combined with one or more separate antimicrobial treatment.

### BACKGROUND OF THE INVENTION

In food processing, food products are often washed, chilled and disinfected in process water baths or water spray with suitable antimicrobial agents. Quite often, these process water baths contains antimicrobials such as chlorine or peracetic acid to control or eliminate unwanted microorganisms, which may be pathogens. Examples of disinfecting processes using process water baths has been described, for example, in U.S. Pat. No. 5,364,650 to Guthery, entitled “Disinfecting Product,” and U.S. Pat. No. 6,605,308 to Shane et al., entitled “Pathogen Management System,” both of which are incorporated herein by reference.

### SUMMARY OF THE INVENTION

In some embodiments, the invention pertains to an acidic viscous liquid composition comprising an aqueous solvent, a food grade acid, and a food grade thickener having a pH from about 2 to about 6 pH units, wherein the composition has a viscosity from about 50 centipoise to about 10,000 centipoise.

In further embodiments, the invention pertains to a method for processing a perishable food product, the method comprising: applying an acidic viscous liquid composition to the surface of the perishable food product in a food processing operation to form a coated food product and performing a further processing step on the coated food product, the acidic viscous liquid having a pH from about 2 to about 6 pH units.

### BRIEF DESCRIPTION OF THER DRAWINGS

FIG. 1A is a schematic depiction of a dipping process to apply an acidic viscous liquid to the food product.

FIG. 1B is a schematic depiction of a spray process to apply an acidic viscous liquid to the food product.

FIG. 2 is a schematic depiction of a food processing procedure involving sequential application of an acidic viscous liquid and subsequently an antimicrobial agent application.

FIG. 3 is a schematic depiction of a poultry processing operation incorporating a station involving the application of an acidic viscous solution to the poultry being processed.

### DETAILED DESCRIPTION OF THE INVENTION

An acidified viscous solution is described to coat a perishable food product during processing to further preservation of the food product. The coating formed on the food product with the acidic viscous solution can be used in combination with a subsequent application or applications of a pathogen control agent in which the acidified viscous coating provides an acidic pH to increase the effectiveness of the pathogen control agent. The acidified viscous solution generally comprises sufficient food grade acid, such as citric acid or acetic acid, to adjust the pH to a desired range. Furthermore, a suitable viscosity modifier, such as methylcellulose, is included in the solution to provide a desired level of viscosity, which assists with the resulting coating staying of the food product for a significant time during processing even if ultimately dissipated from the food product. Due to the high viscosity of the food processing solution, the solution can be sprayed on the perishable food product with the coating formed by the acidic viscous solution providing desired pH adjustment to the food surface through one or more subsequent processing steps. The acidic viscous solution generally does not significantly negatively impact the food quality or introduce any non-consumable constituents, although generally the acidic viscous solution is effectively dissipated before reaching the consumer. The acidic viscous solution can be effectively used in poultry, e.g., chicken, processing as well as in vegetable produce, fruits and other meat processing operations.

The compositions described herein can help to provide improved antimicrobial control during the food disinfection processes. The compositions, i.e., acidic viscous solutions, generally comprise a thickened food grade acid such as citric acid, acetic acid, or a combination thereof. The composition can be applied directly to food products prior to introduction into antimicrobial spray processes and/or process water baths such as chillers, washers, scalders etc. The thickened acid remains in and around the food product for a period of time following sprays with wash or antimicrobial sprays or while immersed within the water baths thereby producing a lower pH “zone” around the food product than the rest of the process water baths. If the food grade acid used is not thickened, however, the composition could be rapidly washed from the food product once placed into the water bath. Thickened acid dissipates or dissolves from the further processed food product, e.g., immersed food product, at a slower rate than a non-thickened acid product and thus can be more effective at providing desirable modification of the food processing procedures. As the treated food product is moved through a spray or water bath, acid dissipates from the thickener and a lower pH environment exists surrounding the food product. Although some acids can act as antimicrobials by themselves, the primary purpose of the thickened acid compositions described herein is to improve the performance of the antimicrobial product already present within the washing or chilling process. In some embodiments, the thickening agent can be added in sufficient amounts to result in a composition with a viscosity from about 50 to about 6000 centipoise.

The acidic viscous solution clings to a food product to which it is applied, and thereby can provide a temporary protective barrier to the food product. However, the acidic viscous solution can be particularly useful to lower the surface pH of the food product to improve the efficacy of subsequent treatments with antimicrobial agents. In particular, the effectiveness of the antimicrobial agents can be significantly influenced by the pH, and the lowering of the pH of the surface of the food product using the solutions described herein can be significantly effective to improve the performance of the antimicrobial treatment without adversely affecting the food product.

The compositions and processes herein can be effectively used for perishable food products, such as vegetable produce, fruits and animal products. In particular, the processing of poultry is discussed in more detail, although the discussion can be correspondingly applied to the processing of vegetables, fruits and other animal products. A general discussion of the disinfection of perishable food products is discussed in U.S. Pat. No. 5,364,650 to Guthery, entitled “Disinfecting Product,” incorporated herein by reference. In general, the food product can be contacted with a disinfecting solution by immersion, by spraying the food product or the like. While acid solutions can provide themselves some antimicrobial or microbial-static effect, desirable antimicrobial treatment can generally be based on a bleach, e.g., hydrochlorite/hydrochlorous acid, or peroxides, e.g., peracedic acids. The acidic viscous solutions herein can be used effectively to improve the antimicrobial treatments.

In the context of a chlorine based treatment, not to be bound by any particular theory of operation, it is believed that in general, pH plays a significant role in the effectiveness of these water baths. For example, poultry chiller water is often chlorinated. At pH ranges above 6.0, the chlorine is present in greater proportion as hypochlorite based on the acid-base equilibrium. At pH ranges below 6.0 chlorine is present as hypochlorous acid and is much more effective at controlling microorganisms than above pH 6.0 so the pH is typically adjusted to improve effectiveness.

An embodiment of poultry processing with hypochlorous acid treatments is described in U.S. Pat. No. 6,605,308 (the '308 patent) to Shane et al., entitled “Pathogen Management System,” incorporated herein by reference. Solid bleach agents generally can comprise hypochlorite salts, such as sodium hypochlorite (NaClO) or calcium hypochlorite (Ca(ClO)₂), and these salts can form hypochlorous acid when contacted with acid. Further reaction of hypochlorous acid with acid can result in chlorine gas release. The acidic viscous solutions described herein are designed to interact with hydrochlorous acid and/or hypochlorite solutions to shift the equilibrium toward hydrochlorous acid (HClO) without excessive outgassing of chlorine gas, Cl₂. Chlorine gas can be hazardous if breathed by people or animals. It is believed that hypochlorous acid can be particularly effective with respect to providing antimicrobial activity relative to the hypochlorite salts. The sequential solution application as described herein can be an effective way to provide enhanced antimicrobial treatment of the food products.

Peroxides can provide desirable antimicrobial activity. Hydrogen peroxide, while a relatively inexpensive sanitizing agent can have adverse effects on food products. Hydrogen peroxide reacts with carboxylic acids, such as acetic acid, to form peroxyacids or peracids, such as peracetic acid, which can provide desired antimicrobial effectiveness with reduced damage to the food product surface. Using the viscous acidic solution processing described herein, the viscous solution can provide the carboxylic acid, such as acetic acid, which can subsequently be contacted with a peroxide spray and/or bath to form the peracid, such as peracetic acid. This approach of forming the peracid in situ is an efficient and generally low expense approach to the sterilization issue.

The viscous acidic solution comprises water, a food acid and a thickener. In general, the components are of reasonable food grade such that the solution is suitable for application to a food product. If desired, the solution can comprise additives generally at concentration each of no more than about 2 weight percent, such as coloring agents, perfumes, odor masking agents, surfactants, UV detectable dyes or the like. In general, the solution comprises food acid in an amount from about 0.01 to about 8 weight percent, in further embodiments from about 0.05 to about 6 weight percent and in other embodiments from about 0.1 to about 4 weight percent food acid. The pH of the viscous acid solution is generally from about 2 to about 6 pH units, in further embodiments from about 3 to about 5.5 and in other embodiments from about 2.6 to about 5 pH units. A person of ordinary skill in the art will recognize that additional ranges of acid concentration and pH within the explicit ranges above are contemplated and are within the present disclosure. Suitable food acids generally include any acid approved for use with food items that can provide the desired pH range at appropriate concentration and can be, for example, citric acid, acetic acid, malic acid, tartaric acid, adipic acid, fumaric acid, succinic acid, ascorbic acid, lactic acid, isoascorbic acid, adipic acid, sulfuric, phosphoric, hydrochloric, and mixtures thereof Also, citric acid can be desirable for use with chlorine bleach antimicrobial agents, and acetic acid can be desirable for use with peroxide antimicrobial agents.

With respect to the thickener, the solution generally comprises from about 0.01 to about 8 weight percent thickener, in further embodiments from about 0.05 to about 6 weight percent and in other embodiments from about 0.1 to about 5 weight percent thickener. The thickener generally is selected to provide an enhanced viscosity from about 50 to about 10,000 centipoise, in further embodiments from about 100 to about 8000 centipoise, in other embodiments from about 200 to about 6000 centipoise and in some embodiments from about 300 to about 3000 centipoise. The viscosity can be measured using a viscometer or rheometer at room temperature and at low shear of 2 s⁻¹. A person of ordinary skill in the art will recognize that additional ranges of thickener concentration and viscosity within the explicit ranges above are contemplated and are within the present disclosure. Suitable thickeners include, for example, cellulose polymer or derivatives thereof, glycerol, polyethylene glycol, polyethyelene oxide, guar gum, polysaccharides, polyvinylalcohol, polyvinylesters, such as polyvinylacetates, polyacrylates, mixtures thereof or the like.

With respect to cellulose thickeners, cellulose refers to a class of natural polymers, and various species of cellulose can be desirable for use as thickeners. Cellulose is a naturally occurring non-nutritional polysaccharide that is found in plants, especially in wood and a variety of natural fibers. The polymer repeat unit in cellulose is D-glucose linked through the 1, 4 carbons with a beta linkage. Cellulose polymer generally refers to a regenerated form of the natural polymer that is formed by dissolving the natural polymer. The dissolving process is believed to reduce the polymer molecular weight through partial degradation of the polymer that results in a reduced crystallinity. Cellulose derivatives can provide desirable viscosity properties. Cellulose derivatives include, for example, cellulose esters, such as cellulose nitrate and cellulose acetate, and cellulose ethers, such as methyl cellulose, ethyl cellulose, hydroyethyl cellulose, hydroxypropyl cellulose, carboxymethyl cellulose, aminoethyl cellulose, and benzyl cellulose. In particular, methyl cellulose, ethyl cellulose and/or carboxymethyl cellulose have desirable properties, such as moderate cost for food grade material and good effectiveness to modify viscosity at moderate concentrations.

In some embodiments, the acidic viscous solution has no more than about 5 weight percent nutritional carbohydrates, in further embodiments no more than about 1 weight percent, in other embodiments no more than about 0.1 weight percent and in some embodiments effectively no nutritional carbohydrates, such as starch, sugars and the like. Nutritional carbohydrates can introduce undesirable contamination to the food product, such as by aerobic microorganisms. A person of ordinary skill in the art will recognize that additional ranges of nutritional carbohydrates within the explicit ranges above are contemplated and are within the present disclosure. Similarly, the acidic viscous solution in some embodiments can generally free of flavorings and/or flavor enhancers, such as tenderizers, although food acids or thickeners can exert some minor influence on flavor as an ancillary effect, and such ancillary flavor effects are not considered as rendering food acids or thickeners as flavors.

In some embodiments, the viscous acidic solution consists essentially of an aqueous solvent, food acids and thickeners. Minor inactive ingredients can be further included, such as coloring agents, fragrance enhancers or the like. The aqueous solvent generally comprises a majority of water by weight and optionally relatively small amounts of some other acceptable organic solvents, such as alcohols. Suitable food acids, thickeners and concentrations are described above.

The viscous acidic solution provides a protective coating with reasonable ability to cling to the food product for a period of time based on the viscosity of the composition. Thus, the viscous acidic solution can provide utility as a protective coating, such as through blocking of contamination. However, the acidic nature of the viscous acidic coating can further provide improved efficacy of antimicrobial treatments based on chlorine bleach, i.e., hypochlorite/hypochlorous acid, and/or peroxide treatments. As noted above, the acidic coating can result in a greater relative amount of hypochlorous acid relative to the base hypochlorite to improved the efficacy of the antimicrobial treatments and in formation of a peroxyacid when reacted with peroxides, such as hydrogen peroxides, to provide effective antimicrobial treatments with reduced amounts of damage to the food product relative to a hydrogen peroxide treatment. To achieve this synergistic antimicrobial effectiveness, the food product is generally subjected to the sequential treatment initially with the viscous acidic viscous solution and then with an antimicrobial agent, such as a peroxide and/or a chlorine agents or the like.

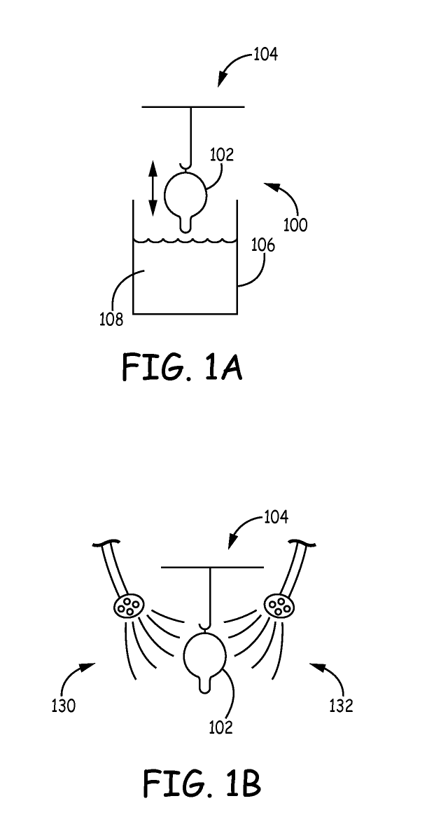

In general, the viscous acidic coating can be applied in any reasonable way to the food product, such as through dipping, spraying, brushing, spreading, combinations thereof or the like. Referring to FIG. 1A, processing system 100 is shown schematically with a food product 102 carried by a conveyor system 104, to a tank 106 holding a reservoir of acidic viscous solution 108 into which food product 102 is lowered and raised to coat the food product. In general, the food product can be any reasonable perishable food product, such as fresh produce, poultry, beef parts, pork products, lamb product, fish, seafood or the like. The conveyor system can be any reasonable system, such as manual systems, although automated system designed for processing the specific food product are generally efficient ways of the handling the food product.

Conveyors can be designed in various supports for the food product, such as with hooks or other hanging supports, belts for supporting the food products, buckets or the like. Referring to FIG. 1B, processing system 130 comprises a food product 102 carried by a conveyor system 104. In processing system 130, conveyor system 104 carries food product 102 past spray system 132. A shown in FIG. 1B, spray system 132 comprises spray elements 134, 136 positioned to spray opposite sides of food product 102 to achieve appropriate coverage. In additional or alternative embodiments, spray system 132 can have 1 spray nozzle, 3 spray nozzles, 4 spray nozzles or more than 4 spray nozzles to provide desired spray coverage. In principle, a spray system can provide fast and efficient processing, for example, with a food product coated with the acidic viscous solution in a few seconds or less.

It may be desirable to cool the acidic viscous solution prior to application to the food product. The cooling process can further increase the viscosity of the solution without increasing the thickener concentration to provide for increased adherence of the solution to the food product. However, the cooling of the solution can be particularly desirable for application to food products that are either heated during the processing and can be advantageously cooled to reduce unwanted cooking of the product and/or are subsequently refrigerated such that precooling can be efficient and advantageous part of the processing. In some embodiments, the acidic viscous solution can be cooled to a temperature from about 32° F. (0° C.) to about 50° F. (10° C.) and in further embodiments from about 33° F. (2° C.) to about 45° F. (7° C.). A person of ordinary skill in the art will recognize that additional ranges of temperature within the explicit ranges above are contemplated and are within the present disclosure.

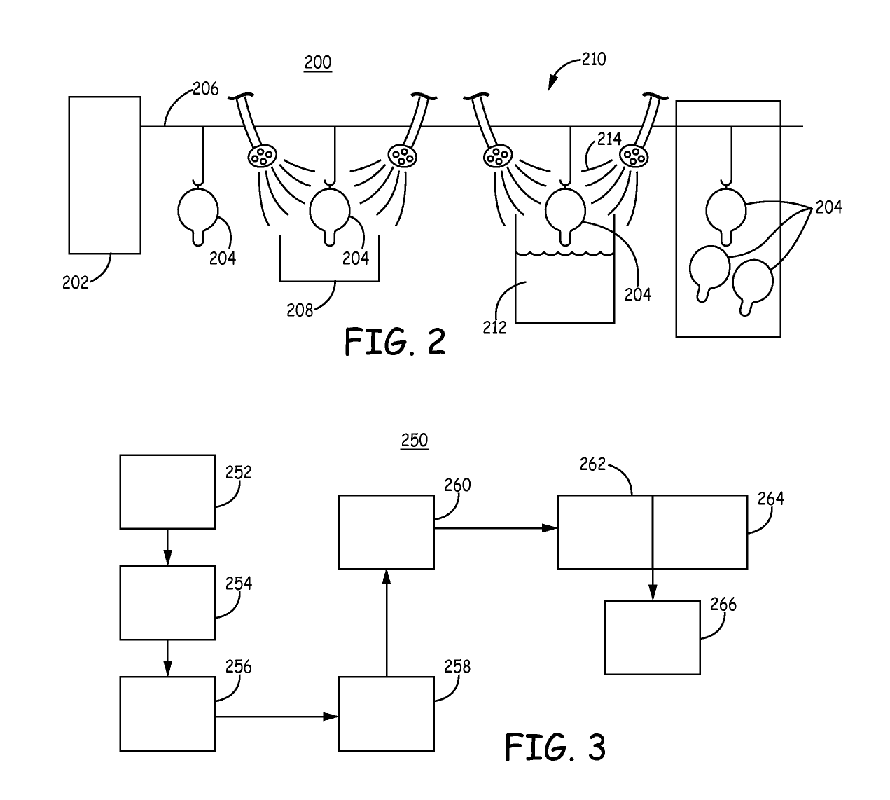

In the context of a food processing facility, a station that applies the acidic viscous solution can be incorporated into an overall processing system. Referring to FIG. 2, a general processing system 200 is shown schematically comprising a food delivery or preparation area 202 from which food products 204 for further processing is delivered with a conveyor 206. Conveyor 206 can transport food product 204 to a station 208 for the application of a viscous acidic solution by immersion, such as shown in FIG. 1A, by spraying, such as shown in FIG. 1B or other suitable application approach. Conveyor 206 can then further transport food product 204 to an antimicrobial processing station 210. At antimicrobial processing station 210, food product can be dipped into an antimicrobial bath 212, such as a hypochlorite/hypochlorous acid bath or a peroxide bath, passed through an antimicrobial spray 214, such as a hypochlorite/hypochlorous acid spray or a peroxide spray, another type of application of an antimicrobial composition, or a combination thereof. Additional stations, such as food processing stations, acidic viscous solution application stations and/or antimicrobial processing stations can be incorporated into the food processing line as appropriate to achieve desired results. In particular, if additional food processing stations are along the processing line where contaminants can be introduced, corresponding additional antimicrobial processing stations can be included appropriately along the processing line, and additional stations for application of acidic viscous solutions may or may not be included. If the acidic viscous solution is retained on the surface of the food product due to the viscous nature of the solution, the food product can be passed through multiple food processing stations and/or antimicrobial stations without additional applications of acidic viscous solution while still benefiting from the contribution of the acidic viscous composition. Generally, after passage through the various processing stations, the food product is transported to a storage/transportation station 220 where the food product is accumulated for longer term storage and/or transportation to remote locations. Storage/transportation station 220 may optionally involve refrigeration and/or immersion of the food product in liquid.

To describe a specific embodiment involving multiple processing stations and antimicrobial treatment stations, reference is made to poultry processing, although the features can be generalized to processing of other food products by a person of ordinary skill in the art based on the teachings herein. Further details of poultry processing in the context of pathogen control is described in the '308 patent cited above. With respect to poultry processing, three pathogen mediation steps can be used in current practices. A first antimicrobial processing step can be performed following killing and de-feathering the bird, a second antimicrobial processing step can be performed following trimming, e.g., removing the neck and feet, and evisceration of the bird, e.g., removal of organs, and a third antimicrobial processing step can be performed after or simultaneously with chilling the bird, which can involve an air blast, water immersion or a combination thereof. Additional antimicrobial processing steps can be used if desired during poultry processing. In some embodiments, a viscous acidic solution application station can be placed before the first antimicrobial processing station, although alternatively the acidic viscous processing solution can be applied later in the process such that all of the antimicrobial process may not benefit from the presence of the acidic viscous solution. Due to the high viscosity at least some of the viscous acidic solution can remain on the poultry product through the relevant portions of the processing procedure, so that the viscous acidic solution may be applied once to introduce the beneficial effects through the processing stages. However, a viscous acidic solution can be applied multiple times through the poultry processing procedure if desired to achieve further beneficial effects.

Referring to an embodiment in FIG. 3, poultry processing unit 250 comprises poultry kill and de-feathering station 252. In a poultry processing environment as well as other meat processing systems, after the animal is killed and perhaps after some additional initial processing, such as the removal of certain body parts, the carcass can be subjected to a scalding process, which can involve brief contact with hot water to reduce the microbial load on the surface of the carcass so that the microbial load is reduced with respect to additional processing. Such an initial scalding step can in principle be used for fruits and vegetables also if desired.

In this embodiment, after de-feathering the poultry product is conveyed to application station 254 where an acidic viscous solution is applied to the poultry product. As noted above, the acidic viscous solution can be cooled prior to application. Cooling of the solution can be particularly desirable if the animal is scalded to reduce the temperature of the food product without increasing the bioload. For poultry and other meat products, cooling the product after scalding may reduce loss of fat from the product due to heat. The poultry product is then subjected to a first antimicrobial treatment at first antimicrobial treatment station 256. The poultry product then is transported to a trimming and evisceration station 258. Following additional processing at station 258, the poultry product can be subjected to a second antimicrobial treatment at second antimicrobial treatment station 260. Poultry are then brought to a chiller section 262. A third antimicrobial treatment station 264 can be placed after the chiller section or integrated with the chiller section. For example, the ‘308 patent described the inclusion of hypochlorous acid/hypochlorite in the water of a chiller for simultaneous chilling and antimicrobial treatment. The chilled poultry product can then be transported to a further processing station or accumulation station 266. In general, the various processing stations in FIG. 3 can comprise multiple physical processing stations that may be spaced along the transport system, and similarly additional processing stations can be included as appropriate, such as washing stations, inspection stations and the like.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. An acidic viscous liquid composition comprising an aqueous solvent, a food grade acid, and a food grade thickener having a pH from about 2 to about 6 pH units, wherein the composition has a viscosity from about 50 centipoise to about 10,000 centipoise.

2. The acidic viscous liquid composition of claim 1 having no more than about 1 weight percent nutritional carbohydrates.

3. The acidic viscous liquid composition of claim 1 being substantially free of any flavoring or flavor enhancers.

4. The acidic viscous liquid composition of claim 1 having a pH from about 2.6 to about 5 pH units.

5. The acidic viscous liquid composition of claim 1 comprising from about 0.05 weight percent to about 6 weight percent food acid.

6. The acidic viscous liquid composition of claim 1 comprising from about 0.05 weight percent to about 6 weight percent thickener.

7. The acidic viscous liquid composition of claim 1 having a viscosity from about 200 centipoise to about 6000 centipoise.

8. The acidic viscous liquid composition of claim 1 wherein the food grade acid comprises citric acid, acetic acid or combinations hereof.

9. The acidic viscous liquid composition of claim 1 wherein the food grade acid comprises malic acid, tartaric acid, adipic acid, fumaric acid, succinic acid, ascorbic acid, lactic acid, isoascorbic acid, adipic acid, sulfuric, phosphoric, hydrochloric, and mixtures thereof.

10. The acidic viscous liquid composition of claim 1 wherein the food grade thickener comprises cellulose.

11. The acidic viscous liquid composition of claim 1 wherein the solvent is water.

12. The acidic viscous liquid composition of claim 1 wherein the solvent is water, the acid is citric acid, acetic acid or a combination thereof, the food grade thickener is cellulose, the pH is from about 3 to about 5.2 pH units, the viscosity is from about 300 to about 3000 centipoise, the acid concentration is from about 0.1 to about 4 weight percent and the thickener concentration is from about 0.1 to about 4 weight percent, and the composition is essentially free of nutritional carbohydrates.

13. A method for processing a perishable food product, the method comprising: applying an acidic viscous liquid composition to the surface of the perishable food product in a food processing operation to form a coated food product and performing a further processing step on the coated food product, the acidic viscous liquid having a pH from about 2 to about 6 pH units.

14. The method of claim 13 wherein the food product is a poultry product.

15. The method of claim 13 wherein the food product is a vegetable, fruit, beef product, pork product or lamb product.

16. The method of claim 13 wherein the applying of the acidic viscous liquid composition comprises dipping, immersing, spraying, brushing, spreading or a combination thereof.

17. The method of claim 13 wherein the further processing step comprises applying an antimicrobial agent to the coated food product.

18. The method of claim 17 wherein the applying of an antimicrobial agent comprises contacting the coated food product with a hypochorite/hypochlorous acid composition.

19. The method of claim 18 wherein the hypochorite/hypochlorous acid composition is applied by spraying.

20. The method of claim 17 wherein the applying of an antimicrobial agent comprises contacting the coated food product with a composition having a peroxide.

21. The method of claim 17 further comprising chilling the food product comprising exposing the food product to a refrigerated air blast and/or a refrigerated bath.

22. The method of claim 13 wherein is water, the acid is citric acid, acetic acid or a combination thereof, the food grade thickener is cellulose, the pH is from about 3 to about 5.2 pH units, the viscosity is from about 300 to about 300 centipoise, the acid concentration is from about 0.1 to about 4 weight percent and the thickener concentration is from about 0.1 to about 4 weight percent, and the composition is essentially free of nutritional carbohydrates.

23. The method of claim 13 wherein the food product is a poultry item, the further processing step comprises contacting the coated food product with a hypochlorite/hypochlorous acid composition, and the applying of the acidic viscous liquid composition comprises spraying.
